(19) United States
(12) Patent Application Publication
(10) Pub. No.: US 2008/0308128 A1
(43) Pub. Date: Dec. 18, 2008

(54) AUTOMATED SYSTEM FOR WATERWALL CLEANING AND INSPECTION

(75) Inventors: Jacques L. Brignac, Simsbury, CT (US); Roland R. Moser, Zurich (CH)

Correspondence Address: CANTOR COLBURN, LLP - ALSTOM POWER, 20 Church Street, 22nd Floor, Hartford, CT, 06103, US

(73) Assignee: ALSTOM TECHNOLOGY LTD, Baden (CH)

(21) Appl. No.: 11/761,481

(22) Filed: Jun. 12, 2007

(51) Int. Cl. B08B 7/04; B08B 3/00; B08B 3/02; G06G 7/48; B08B 3/04

(52) U.S. Cl. 134/18; 134/56 R; 703/5

(57) ABSTRACT

An automated cleaning and inspection system includes movement components for moving the system along water-wall tubing disposed in a combustor, cleaning components for cleaning the water-wall and inspecting components for inspecting the water-wall; wherein the moving, cleaning and inspecting are coordinated for automated performance. A computer program product and a method are provided.

### BACKGROUND OF THE INVENTION

1. Field of the Invention

The invention disclosed herein relates to combustion systems and, in particular, to preparation and inspection of waterwall systems.

2. Description of the Related Art

Combustion systems make use of a variety of devices for generation of steam and moving that steam. One such combustion system is a boiler. In a furnace of some boilers, is a “waterwall.” The waterwall typically lines the walls of the furnace and includes a plurality of tubes that are welded together. During operation, the tubes carry water (i.e., coolant) into the furnace where combustion takes place. The heat of combustion is transferred to the waterwall and steam is generated within the tubes. As one might imagine, in such a harsh environment, the tubes are subject to degradation. Accordingly, system operators conduct periodic inspections of the tubes to ensure efficient operation.

Referring now to FIG. 1, there are shown aspects of an embodiment of a Steam Generation System (SGS) 10. As depicted, the SGS 10 includes a combustor 2 and various other components. One skilled in the art will recognize that this illustration and description present only a section of a simplified combustion system, and that this example is not limiting of combustion systems.

In operation, crushed fuel (e.g., coal) and sorbent (e.g., limestone) are fed to a lower portion of the combustor 2 as bed material. Primary air is supplied to a bottom portion of the combustor 2 through an air distributor, with secondary air fed through one or more elevations of air ports in a lower portion of the combustor 2.

Combustion takes place throughout the combustor 2, which is filled with the bed material. Flue gas and entrained solids leave the combustor 2 as combustor exhaust through a gas outlet 7.

In typical embodiments, the combustor 2 generally includes two regions. A lower portion and an upper portion. The lower portion of the combustor 2 includes the fuel, a primary air distributor, secondary air ports, fuel feed ports and solids recycle ports. The density of the bed in this region it relatively high on average and typically highest at the elevation of the air distributor. The density then drops off with increasing height of the combustor 2. Physically, the lower portion is usually rectangular, tapered and formed from finned or fusion welded water-wall tubing 15. The lower portion is typically lined with refractory to protect the water-wall tubing 15.

In this simplified illustration, the water-wall tubing 15 is supplied boilerwater (e.g., water, water with certain chemicals, etc, . . . ) by an inlet header 17. The inlet header 17 provides the boilerwater for steam generation in the water-wall tubing 15 of the combustor 2.

The upper portion of the combustor 2 is usually rectangular with vertical walls, where the walls are formed with finned or fusion welded water-wall tubing 15. The upper portion is typically unlined to maximize heat transfer to the water-wall tubing 15. The walls of the combustor 2 are cooled by circulation in the water-wall tubing 15.

Still referring to FIG. 1, the prior art SGS 10 includes a boiler drum 8 which receives steam and moisture from the water-wall tubing 15 (through various components, such as a collection header). The boiler drum 8 provides for separation of water (W) and steam (S).

As one might surmise, having an efficient combustion system calls for including as great a surface area as possible with the water-wall tubing 15. In some embodiments, the surface area of the water-wall tubing 15 is up to about 7,000 square meters (m²).

Typically, inspection of the water-wall tubing 15 is performed about once a year. In order to do so, extensive cleaning is required. Cleaning and inspection requires erection of scaffolding and often at least ten (10) days for completion.

Therefore, what are needed are improved cleaning and inspection techniques for evaluation of water-wall tubing. Preferably, the techniques provide for reduced labor and time savings.

### BRIEF SUMMARY OF THE INVENTION

Disclosed is an automated cleaning and inspection system including: movement components for moving the system along water-wall tubing disposed in a combustor, cleaning components for cleaning the water-wall and inspecting components for inspecting the water-wall; wherein the moving, cleaning and inspecting are coordinated for automated performance.

Also disclosed is a computer program product stored on machine readable media, the product including instructions for performing automated cleaning and inspection of water-wall tubing disposed within a combustor, the instructions including instructions for: coordinating movement of the system in relation to the water-wall tubing; cleaning of the water-wall tubing; and inspecting the water-wall tubing.

In addition, a method for cleaning and inspecting water-wall tubing disposed on an interior surface of a combustor is disclosed and includes: selecting an automated system for cleaning and inspecting water-wall tubing; disposing the automated system into a relationship with the water-wall tubing; and initiating operation of the automated system.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts aspects of a prior art combustor having water-wall tubing;

FIG. 2 depicts aspects of an automated system for cleaning and inspecting water-wall tubing; and

FIG. 3 depicts an embodiment of the automated system in an operational configuration.

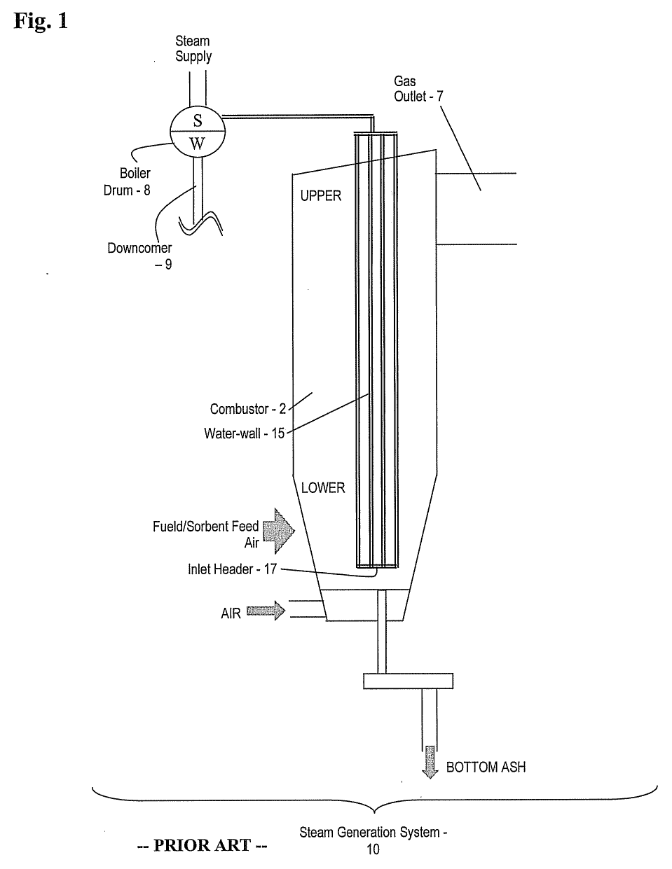

### DETAILED DESCRIPTION OF THE INVENTION

Disclosed are methods and apparatus providing for automated cleaning and inspection of water-wall tubing 15 of a Steam Generation System (SGS) 10. One skilled in the art will recognize that a variety of systems and designs may make use of the water-wall tubing 15. Accordingly, these systems and designs fall within the scope of a SGS 10 as described herein.

As discussed herein, the term “automated” makes reference to performance of a task, such as cleaning or inspection, without continuous supervision or intervention by an operator. Accordingly, the term “manual” generally makes reference to tasks that are performed step by step or directly by an operator or laborer. It is considered that semi-automated performance, such as performance of a task with periodic supervision or intervention, falls within the realm and meaning of the term “automated.”

As used herein, it is considered that the automated system 100 is useful for at least one of cleaning and inspection of water-wall technology implemented in most any embodiment of a combustor 2 or combustion chamber.

In general, the water-wall tubing 15 includes a plurality of tubes for carrying water (i.e., coolant, which may include water and other chemicals, such as corrosion and erosion inhibitors). The water-wall tubing 15 is disposed along interior portions of a combustion chamber.

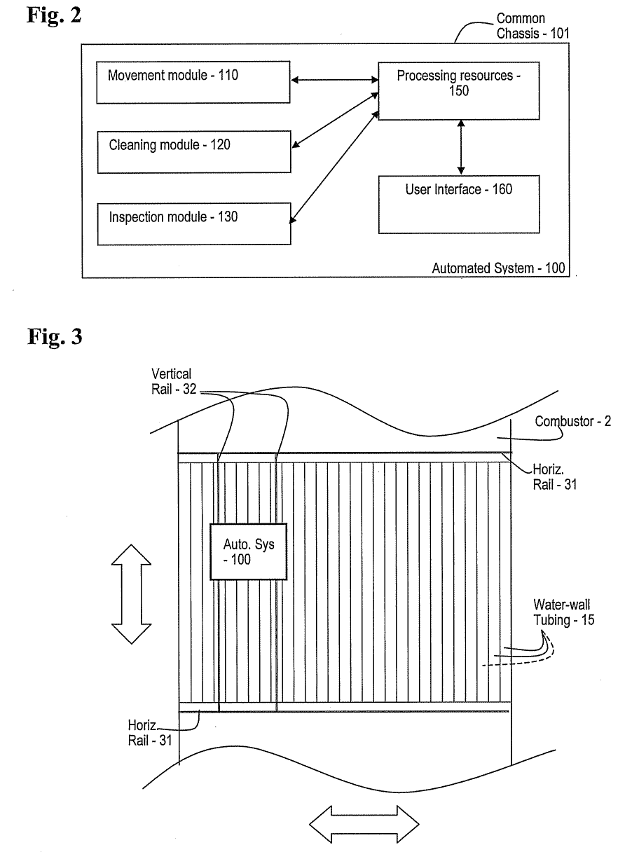

Refer now to FIG. 2 which illustrates aspects of an automated system 100 for cleaning and inspection of water-wall tubing 15. In this exemplary embodiment, the automated system 100 includes components generally functionally classified as being useful for one of movement, cleaning and inspection. Processing resources 150 are typically included to provide for coordination between the three classifications of components. For convenience and discussion only, components for each functional classification are regarded as belonging to a “module.”

In FIG. 2, the automated system 100 includes a movement module 110, a cleaning module 120 and an inspection module 130, which may be mounted on a common chassis 101. The movement module 110 moves the automated system 100 along the exposed surface of the waterwall tubing. The movement module 110 may include components such as motors, servos, tracks, gears, pulleys, chains, ropes, cables, transmissions, power supplies, distance measuring equipment, position sensors, interfaces and other such components to effect this movement. The cleaning module 120 removes slag or other build-up from the surfaces of the waterwall tubes to allow for non-destructive testing of the waterwall tubes. The cleaning module 120 may include components such as fixed or movable brushes, fixed or movable abrasives, an abrasive jet (i.e., a sanblaster), a liquid jet (i.e., a hydrolaser or a pressure washer), a chemical jet (typically a lower pressure dispenser of cleaning chemicals), power supplies, interfaces and other such components. The inspection module 130 may include components used for non-destructive testing of the waterwall tubes, such as a camera, lighting, ultrasonic testing, x-ray examination, radiographic examination, magnaflux testing, eddy-current testing as well as equipment, power supplies, interfaces and other such components for other types of testing. Also included are processing resources 150 as well as a user interface 160.

The processing resources 150 may include components such as a processor, memory, storage, an interface, a power supply, a bus, an input, an output, a connection, an interface and other such components. In this embodiment, the processing resources 150 provides a user with the user interface 160. The user interface 160 is useful for various tasks including at least one of programming, monitoring, directing, calibrating, positioning, starting and shutting down of the automated system 100. In some embodiments, these tasks are performed, at least in part, by computer implemented instructions.

In some embodiments, the automated performance of moving, cleaning and inspecting is performed according to computer implemented instructions executed in the processing resources 150. In other embodiments, the processing resources 150 do not exist as such. Stated another way, in some embodiments, the automated system 100 is a “dumb” system that follows a prescribed routine once the automated system 100 is started. For example, once the automated system is turned on, it progresses in one direction performing cleaning or inspecting until redirected (such as by actuation of a sensor).

Of course, the various components of each module may appear in another module or serve multiple uses. Accordingly, the embodiment of FIG. 2 is merely illustrative of aspects of the automated system 100.

In typical embodiments, external apparatus provide for assistance in movement or operation of the automated system 100. Reference may be had to the exemplary embodiment of FIG. 3. In FIG. 3, a rail system is depicted. The rail system includes horizontal rails 31 and vertical rails 32. In some embodiments, the horizontal rails 31 are disposed within the combustor 2 by secure fastening to walls of the combustor 2. In other embodiments, the horizontal rails 31 are installed at the commencement of inspection. Also shown are vertical rails 32, which may be a permanent or temporary installation. In this embodiment, the vertical rails 32 hang from and move along the horizontal rails 31 by use of pulleys and wheels, as known in the art (not shown). The operation of the pulleys and wheels is typically provided for by the automated system 100. The automated system 100 may be equipped for other modes of operation, such as remote operation. One skilled in the art will readily imagine and understand the many iterations and components that may be used for implementation of the rail system.

The automated system 100 is typically adapted for use in a variety of systems implementing water-wall technology. That is, the automated system 100 is not limited to flat water-walls, horizontal implementations nor vertical implementations of water walls.

Typically, at least for the embodiment of FIG. 3, a calibration routine is used. That is, the automated system 100 may use a point of origin as a reference. In this manner, location information for inspection points are all clearly related and defined. Subsequent maintenance of the water-wall tubing 15 may be easily achieved by interpretation and use of the location information.

The location information may be derived by mechanical apparatus (such as by tracking revolutions of wheels along the rails) or by various electronic apparatus (such as by triangulation with wireless systems, or optical range finders). These and other types of distance measuring equipment as are known in the art may be used.

Various other techniques for deployment may be used. For example, deployment may be by a “scissors lift” deployed on a floor of the combustor, by a crane above, any by other techniques as known to one skilled in the art.

In some embodiments, the automated system 100 is programmed for one of determining and following a cleaning or inspection protocol. For example, the automated system 100 may be programmed for 100 percent coverage of the water-wall tubing 15. In other embodiments, the automated system 100 performs at least one of cleaning and inspection according to statistical tests. In further embodiments, the automated system 100 is loaded with maintenance information and historical data. The automated system 100 may determine likely failure points and perform inspection, or additional inspections, at the failure points. The automated system 100 is typically equipped to be responsive to hold points or other predetermined conditions. For example, the automated system 100 may at least temporarily terminate operation under certain conditions, issue an alarm, communicate, such as by sending an SMS message (e.g., issuing a test result code) or perform some other such task.

Of course, more than one automated system 100 may be used at a time. That is multiple units may be used to reduce cleaning and inspection time. In some embodiments, one unit performs cleaning while a secondary unit follows and performs inspection. In typical embodiments, use of the automated system 100 provides for a substantial reduction in outage time (for example, about ninety percent).

Typically, the automated system 100 is equipped for high temperature operation. That is, the automated system is adapted for use during a cool-down cycle in the combustor 2, prior to such temperatures as where manual inspection could normally occur.

One skilled in the art will recognize that a great number of mechanical, electromechanical, electrical, optical and other such devices may be used advantageously with the automated system 100 and in support of at least one of cleaning and inspection of water-wall tubing 15.

In support of the teachings herein, various analysis components may be used, including digital and/or an analog components, such as for providing system control. The components may have sub-components such as a processor, storage media, memory, input, output, communications links, user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An automated cleaning and inspection system comprising:
movement components for moving the system along water-wall tubing disposed in a combustor, cleaning components for cleaning the water-wall tubing and inspecting components for inspecting the water-wall tubing;
wherein the moving, cleaning and inspecting are coordinated for automated performance.

2. The system as in claim 1, wherein the movement components comprise at least one of a rail system, a scissors lift and a crane.

3. The system as in claim 1, wherein the movement components comprise at least one of a motor, a servo, a track, a gear, a pulley, a chain, a rope, a cable, a transmission, a power supply, a distance measuring equipment, a position sensor and an interface.

4. The system as in claim 1, wherein the cleaning components comprise at least one of a brush, an abrasive, an abrasive jet, a liquid jet, a chemical jet, a power supply and an interface.

5. The system as in claim 1, wherein the inspecting components comprise equipment for non-destructive testing.

6. The system as in claim 1, wherein the inspecting components comprise at least one of a camera, a light source, equipment for ultrasonic testing, equipment for x-ray examination, equipment for radiographic examination, equipment for magnaflux testing, equipment for eddy-current testing, a power supply and an interface.

7. The system as in claim 1, further comprising processing resources for coordinating the automated performance.

8. The system as in claim 7, wherein the processing resources comprise at least one of a processor, storage media, a memory, an input, an output, a communications link, a power supply, a connection, an interface, a software program, a digital signal processor and an analog signal processor.

9. The system as in claim 1, wherein the components are adapted for use in a high-temperature environment.

10. The system as in claim 1, wherein the components are mounted to a common chassis for moving along the surface of the waterwall tubes.

11. A computer program product stored on machine readable media, the product comprising instructions for performing automated cleaning and inspection of water-wall tubing disposed within a combustor, the instructions comprising instructions for:
coordinating movement of the system in relation to the water-wall tubing;
cleaning of the water-wall tubing; and
inspecting the water-wall tubing.

12. The computer program product as in claim 11, further comprising instructions for performing at least one of programming, monitoring, directing, calibrating, positioning, starting and shutting down of equipment for at least one of the cleaning and inspection.

13. The computer program product as in claim 11, further comprising instructions for at least one of determining and following a protocol for at least one of cleaning and inspecting.

14. The computer program product as in claim 11, further comprising instructions for logging inspection data.

15. The computer program product as in claim 11, further comprising instructions for at least one of determining and providing location information.

16. A method for cleaning and inspecting water-wall tubing disposed on an interior surface of a combustor, the method comprising:
selecting an automated system for cleaning and inspecting water-wall tubing;
disposing the automated system into a relationship with the water-wall tubing; and
initiating operation of the automated system.
